(19) United States
(12) Patent Application Publication
(10) Pub. No.: US 2006/0164181 A1
(43) Pub. Date: Jul. 27, 2006

(54) Coupling flatness compensated directional coupler

(76) Inventor: Lu Chen, Brooklyn, NY (US)

Correspondence Address: Kevin Redmond, 6960 SW Gator Trail, Palm City, FL, 34990, US

(21) Appl. No.: 11/040,793

(22) Filed: Jan. 24, 2005

(51) Int. Cl. H01P 5/18

(52) U.S. Cl. 333/116

(57) ABSTRACT

A directional coupler that has improved coupling flatness. The directional coupler includes a first, second and third coupler. Each of the couplers has an input port, an output port, a forward coupled port and a reverse coupled port. The forward coupled port of the first coupler is connected to the input port of the second coupler. The reverse coupled port of the first coupler is connected to ground. The output port of the second coupler is connected to the input port of the third coupler. The output port of the third coupler forms a second forward coupled port. The second and third couplers reduce the variation in coupling over a frequency range.

### BACKGROUND

1. Field of the Invention

This invention relates to directional couplers in general and more particularly to a directional coupler that has an improved variation in coupling over the frequency range.

2. Description of Related Art p Directional couplers are used in a variety of applications in the RF and microwave frequency range. FIG. 1 shows a schematic diagram of a prior art directional coupler 20 including a pair of coupled circuit lines 22 and 24. Circuit lines 22 and 24 would typically be formed in a stripline configuration. The directional coupler 20 has four ports, an input port 25, an output port 26, a forward coupled port 27 and a reverse coupled port 28. An input signal or power applied to the input port 25 will go mainly to the output port 26. A portion of the input signal will be electromagnetically coupled to circuit line 24 and appear mostly at forward coupled port 27. A very small portion of the signal will go to the reverse coupled port 28. The electrical signal coupled to the forward and reverse ports depends upon the coupled circuit line characteristic impedance and the coupling between the lines.

Several measurements are used to quantify the electrical performance of a coupler. Insertion loss is defined as the ratio of power at the input port to the power appearing at the output port. Coupling coefficient is defined as the ratio of power at the input port to the power appearing at the coupled port. Coupling flatness is a measure of the peak to peak variation in the coupling coefficient over a particular frequency range. Directivity is a measure of the coupler differentiation. Directivity is defined as the difference in dB of power at the coupled port when power is transmitted in one direction to the power at the same port when power is transmitted in the opposite direction. Return loss is a measure of the reflected signal to the incident signal.

Referring to FIGS. 2-4, the electrical performance of directional coupler 20 is shown. FIG. 2 is a graph of insertion loss versus frequency. FIG. 3 is a graph of coupling and directivity versus frequency. FIG. 4 is a graph of return loss versus frequency for the directional coupler of FIG. 1.

The coupling flatness of a coupler is a limiting parameter in the application of the coupler. Various compensation circuits can be used to increase the bandwidth while maintaining an acceptable flatness. An example of a compensation circuit to improve flatness is a multi-section TEM mode synthesis circuit. Unfortunately, this circuit needs a large printed circuit board to accommodate the quarter wavelength circuit lines needed for each section.

A continuing need exists for a directional coupler that has improved electrical performance and in particular a directional coupler that has improved coupling flatness.

### SUMMARY

It is a feature of the invention to provide a directional coupler that has a small size with good electrical performance.

A further feature of the invention is to provide a directional coupler that has improved coupling flatness.

Another feature of the invention is to provide a directional coupler that includes a a first, second and third coupler. Each of the couplers has an input port, an output port, a forward coupled port and a reverse coupled port. The forward coupled port of the first coupler is connected to the input port of the second coupler. The reverse coupled port of the first coupler is connected to ground. The output port of the second coupler is connected to the input port of the third coupler. The output port of the third coupler forms a second forward coupled port. The second and third couplers reduce the variation in coupling over a frequency range.

### BRIEF DESCRIPTION OF THE DRAWINGS

FIG. 1 is a schematic drawing of a conventional directional coupler of the prior art.

FIG. 2 is a graph of insertion loss versus frequency for the directional coupler of FIG. 1.

FIG. 3 is a graph of coupling and directivity versus frequency for the directional coupler of FIG. 1.

FIG. 4 is a graph of return loss versus frequency for the directional coupler of FIG. 1.

FIG. 5 is a schematic drawing of a directional coupler in accordance with the present invention.

FIG. 6 is a top view of the directional coupler of FIG. 5 packaged on a circuit board and housing.

FIG. 7 is a top view of the circuit board of FIG. 6.

FIG. 8 is a graph of insertion loss versus frequency for the directional coupler of FIG. 5.

FIG. 9 is a graph of coupling and directivity versus frequency for the directional coupler of FIG. 5.

FIG. 10 is a graph of return loss versus frequency for the directional coupler of FIG. 5.

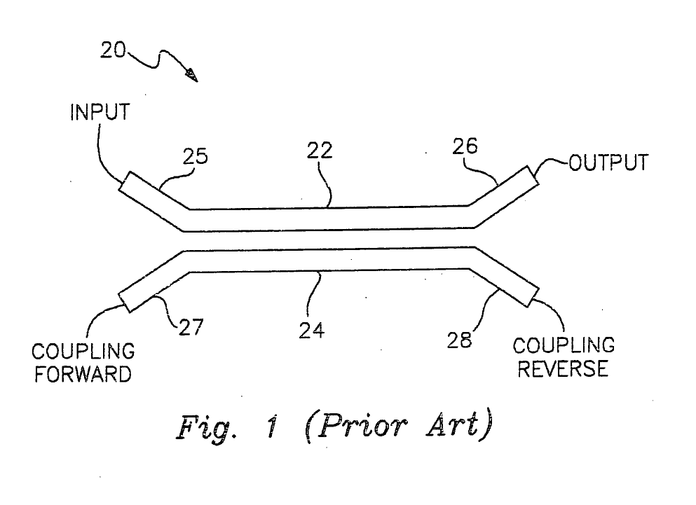

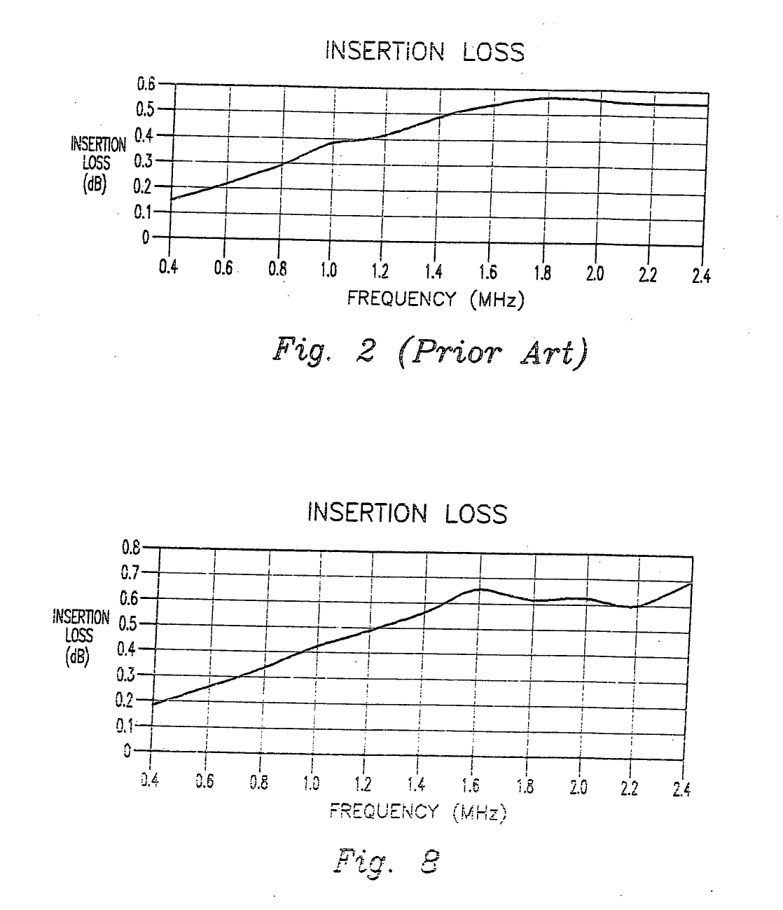

It is noted that the drawings of the invention are not to scale. In the drawings, like numbering represents like elements between the drawings.

### DETAILED DESCRIPTION

FIG. 5 shows a schematic drawing of a coupling flatness compensated directional coupler 30 in accordance with the present invention. Directional coupler 30 has three interconnected couplers 40, 60 and 80. Coupler 40 has a pair of coupled circuit lines 42 and 44. Circuit lines 42 and 44 can be formed in a stripline configuration. Circuit line 42 has ends 42A and 42B. Circuit line 44 has ends 44A and 44B. Coupler 40 has four ports, an input port 45, an output port 46, a forward coupled port 47 and a reverse coupled port 48. Input port 45 is connected to end 42A. Output port 46 is connected to end 42B. A reverse coupled port 48 can be located at end 44B making directional coupler 30 a bidirectional coupler. In FIG. 5, end 44B is shown connected to a 50 ohm terminating resistor 50 making the directional coupler a uni-directional coupler. Resistor 50 is connected between end 44B and ground.

3 dB Coupler 60 has a pair of coupled circuit lines 62 and 64. Circuit lines 62 and 64 can be formed in a stripline configuration. Circuit line 62 has ends 62A and 62B. Circuit line 64 has ends 64A and 64B. End 62A is connected to end 44A. End 64A is connected through a 50 ohm resistor 66 to ground. End 64B is connected through a 50 ohm resistor 67 to ground. Coupler 60 also has four ports, end 62A is the input port, end 62B is the output port, end 64A is the forward coupled port and end 64B can be the reverse coupled port.

3 dB Coupler 80 has a pair of coupled circuit lines 82 and 84. Circuit lines 82 and 84 can be formed in a stripline configuration. Circuit line 82 has ends 82A and 82B. Circuit line 84 has ends 84A and 84B. End 82A is connected to end 62B. End 84A is connected through a 50 ohm resistor 86 to ground. End 84B is connected through a 50 ohm resistor 87 to ground. End 82B is connected to forward coupled port 88.

Coupler 80 also has four ports, end 82A is the input port, end 82B is the output port, end 84A is the forward coupled port and end 84B can be the reverse coupled port. The use of the 3 dB couplers 60 and 80 reduces the variation in coupling coefficient or coupling flatness.

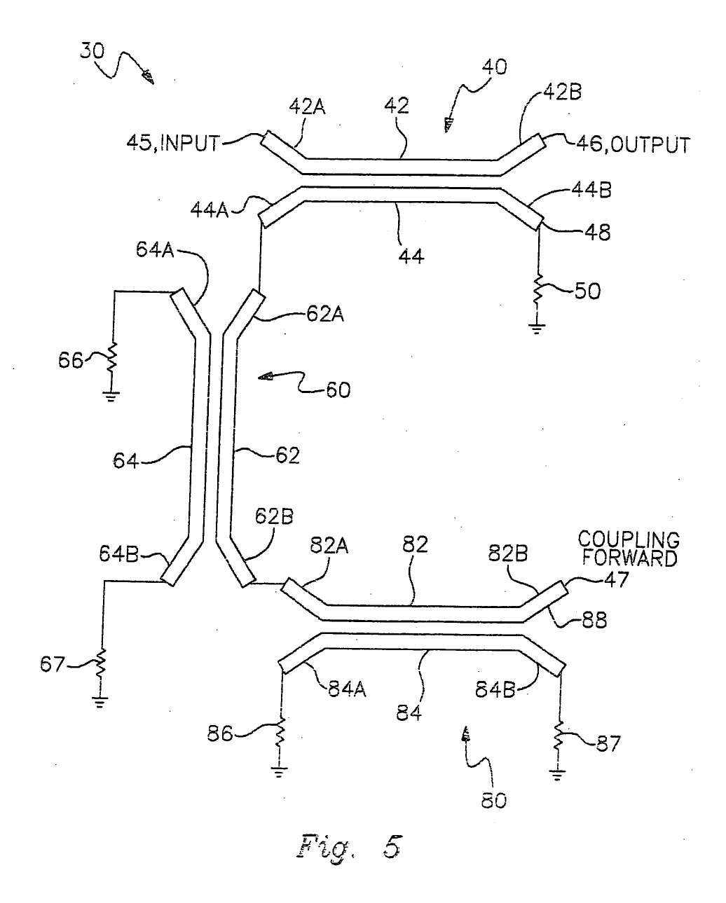

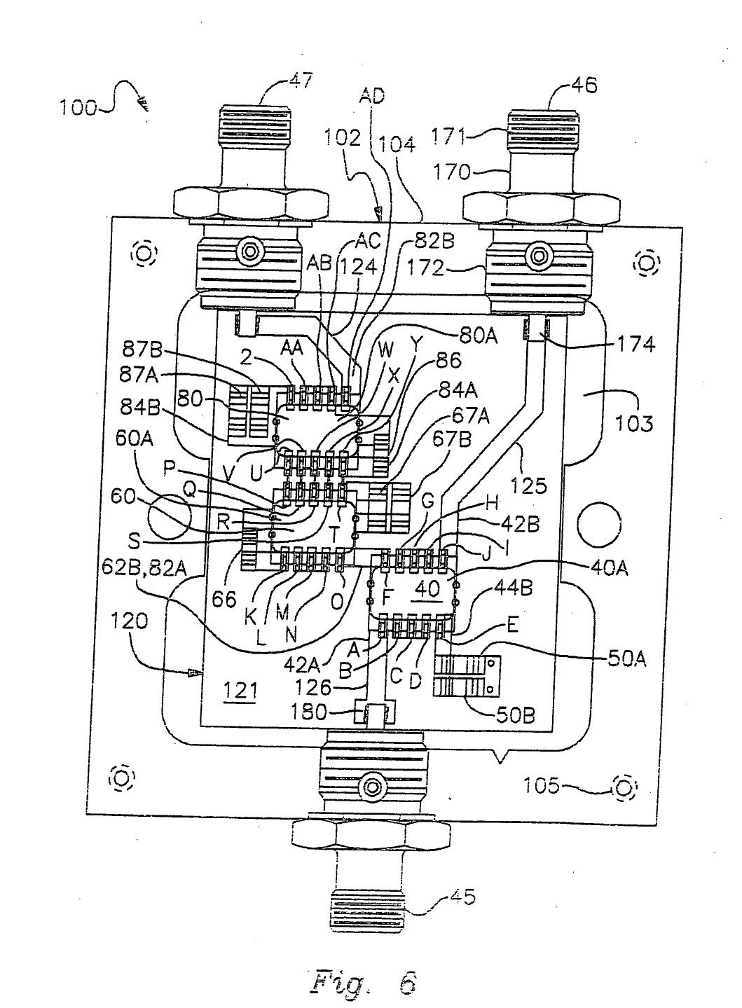

Referring to FIGS. 6 and 7, a top view of directional coupler assembly 100 is shown. FIG. 6 shows the directional coupler 30 of FIG. 5 realized in a physical package.

Directional coupler assembly 100 has a housing 102 with a cavity 103, sides 104 and screw holes 105. Apertures 106 extend through sides 104. Housing 102 would typically be made of metal. A metal cover (not shown) would typically go over cavity 103 and be attached with screws into holes 105.

Several coaxial connectors 170 are threaded into apertures 106. Coaxial connectors 170 have threaded ends 171 and 172 and a pin 174. Coaxial connectors 170 serve as input port 45, output port 46 and forward coupled port 47. Coaxial connectors 170 can be an SMA type coaxial connector. Housing 102 would typically be grounded.

A printed circuit board 120 is mounted inside cavity 103. Printed circuit board 120 has a top surface 121 and a bottom surface (not shown). The bottom surface can have a ground plane that is soldered to a connector. Printed circuit board 120 would typically have several layers that are connected by plated through holes (not shown). The printed circuit board has overall dimensions of 1.38 inches by 1.23 inches. Printed circuit board 120 has several conductive lines and conductive pads patterned on top surface 121. The lines and pads are typically formed from etched copper. Conductive printed circuit lines 124, 125 and 126 are located on surface 121. The circuit lines can have a typical line width of 0.064 inches. Conductive printed circuit pads 127, 128, 129, 130, 131, 132, 133, 134, 135 and 136 are also located on surface 121.

Coupler 40 and 3 dB couplers 60 and 80 are mounted on top surface 121. Coupler 40 and 3 dB couplers 60 and 80 are commercially available from Mini-Circuits Corporation of Brooklyn, N.Y. Coupler 40 and 3 dB couplers 60 and 80 can be formed from low temperature co-fired ceramic (LTCC) material with internal coupled lines. The couplers have metal leads extending away from the coupler bodies 40A, 60A and 80A. The leads are soldered to the printed circuit lines and pads.

Coupler 40 has leads A, B, C, D, E, F, G, H, I and J. Lead A is connected to circuit line 126. Leads B, C, D, G, H and I are connected to circuit pad 134. Lead F is connected to circuit pad 133. Lead J is connected to circuit line 125.

Coupler 60 has leads K, L, M, N, O, P, Q, R, S and T. Lead K is connected to circuit pad 132. Leads L, M, N, Q, R and S are connected to circuit pad 128. Lead O is connected to circuit pad 133. Lead P is connected to circuit pad 129. Lead T is connected to circuit pad 131.

Coupler 80 has leads U, V, W, X, Y, Z, M, AB, AC and AD. Lead U is connected to circuit pad 129. Leads V, W, X, AA, AB, and AC are connected to circuit pad 128. Lead Y is connected to circuit pad 130. Lead Z is connected to circuit pad 127. Lead AD is connected to circuit line 124.

Resistors 50, 66, 67, 86 and 87 are soldered to the lines and pads on top surface 121. Resistors 50, 67 and 87 are made up to two resistors 50A, 50B, 67A, 67B, 87A and 87B, respectively that are connected in parallel. The resistors can be conventional surface mount electronic components. Conventionally, a solder paste is screened onto selected portions of the circuit lines and pads and the components placed with a pick and place machine and the solder paste is then reflowed.

Resistors 50A and 50B are connected between circuit pads 135 and 136. Resistor 66 is connected between circuit pads 128 and 132. Resistors 67A and 67B are connected between circuit pads 128 and 131. Resistor 86 is connected between circuit pads 128 and 130. Resistors 87A and 87B are connected between circuit pads 128 and 127.

The pins 174 of coaxial connectors 170 are connected to circuit lines 124, 125 and 126, respectively by solder 180.

A directional coupler assembly. 100 was designed, fabricated and tested for electrical performance. Directional coupler assembly 100 was tested over the frequency range of 400 to 2400 MHz.

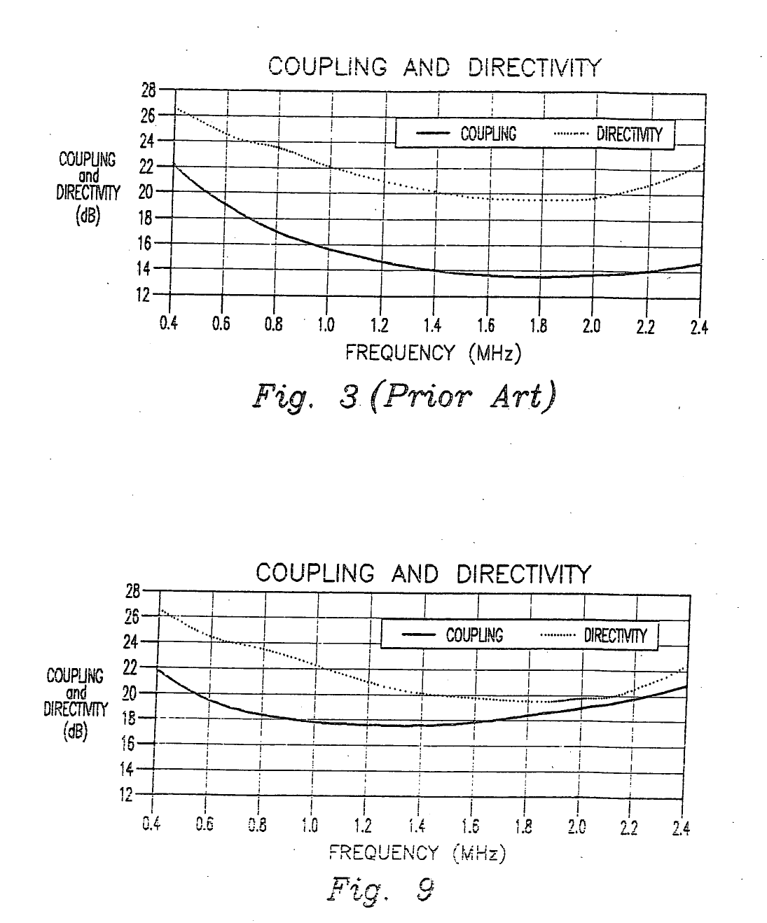

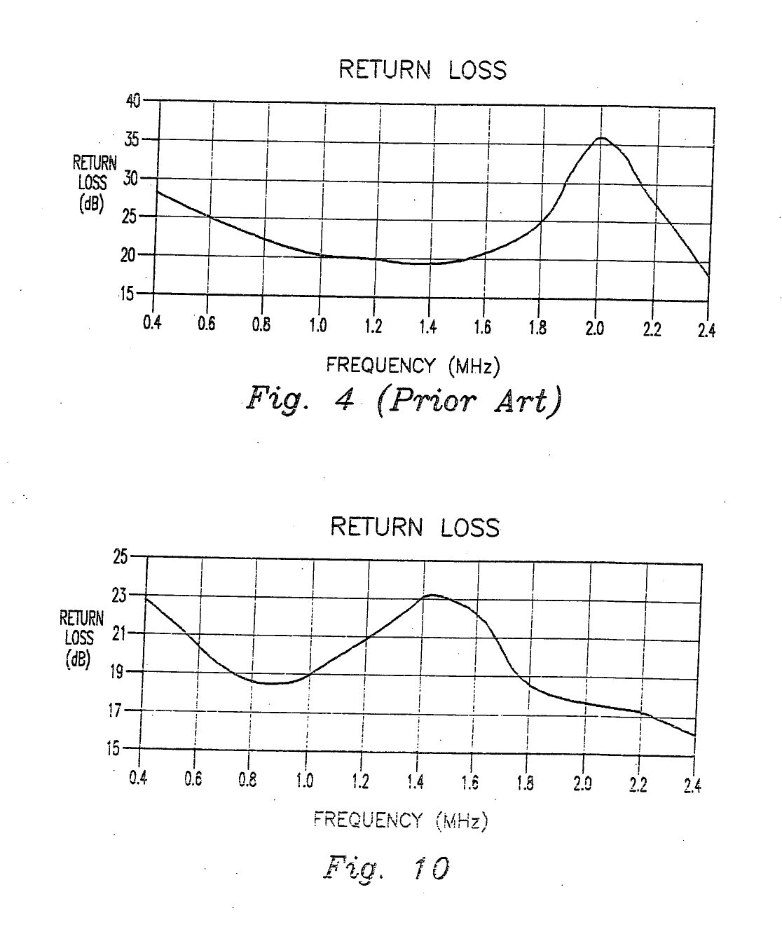

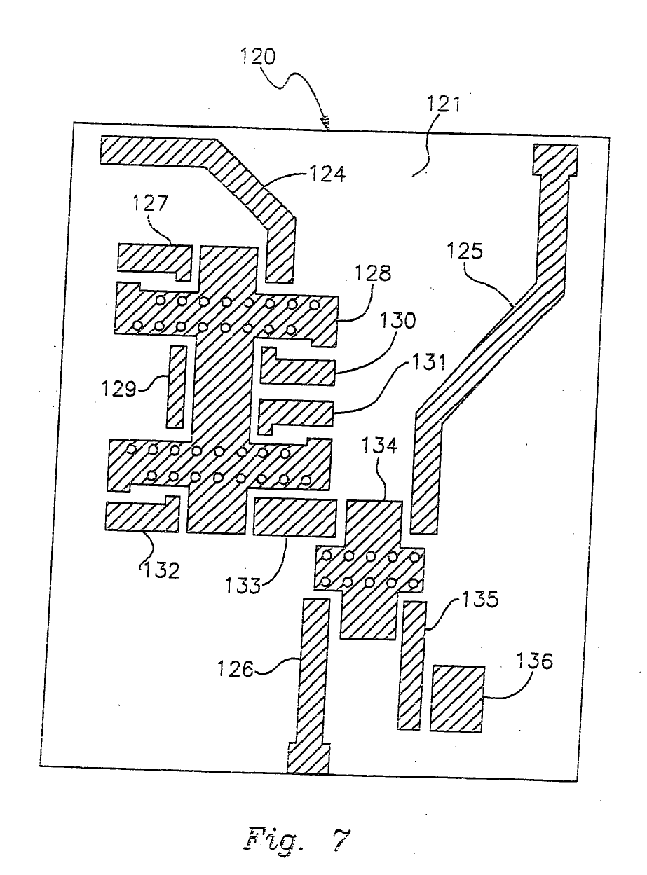

FIGS. 8, 9 and 10 show the electrical performance of directional coupler assembly 100. FIG. 8 shows a graph of insertion loss versus frequency for directional coupler assembly 100. FIG. 9 shows a graph of coupling and directivity versus frequency for directional coupler assembly 100. In FIG. 9, the coupling varied 1.98 dB over the frequency range of 400 to 2400 MHz. In comparison, FIG. 3 shows the coupling variation in a directional coupler of the prior art. The coupling variation for directional coupler 20 was 4.38 dB over the frequency range of 400 to 2400 MHz. Therefore, by the use of the present invention the coupling flatness was improved from 4.38 dB to 1.98 dB. FIG. 10 is a graph of return loss versus frequency for directional coupler assembly 100.

The present invention has several advantages. The present invention provides an improvement in coupling flatness measurements over directional couplers of the prior art.

The use of 3 dB couplers 60 and 80 results in a smaller package size since quarter wavelength circuit lines are not needed.

The use of 3 dB couplers 60 and 80 results in a directional coupler that can handle a wider frequency range.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the description. All changes that come within the meaning and range of equivalency of the claims are to be embraced within their scope.

What is claimed is:

1. A directional coupler comprising:
a) a first circuit line having a first end and a second end;
b) an input port connected to the first end and an output port connected to the second end;
c) a second circuit line having a third end and a fourth end, the first and second circuit lines located proximate to each other such that they are electromagnetically coupled;
d) a second coupler and a third coupler, the second and third coupler connected in series, the second coupler input port connected to the third end; and
e) an output port connected to the third coupler.

2. The directional coupler according to claim 1, wherein a first resistor is connected between the fourth end and ground.

3. The directional coupler according to claim 1, wherein a reverse coupled port is connected to the fourth end.

4. The directional coupler according to claim 1, wherein the second and third couplers reduce the variation in coupling between the first and second circuit lines over a frequency range.

5. The directional coupler according to claim 1, wherein the second coupler comprises:
a third circuit line having a fifth and sixth end;
a fourth circuit line having a seventh and eighth end, the seventh end connected to the third end, the third and fourth circuit lines located proximate to each other such that they are electromagnetically coupled;
a second resistor connected between the fifth end and ground; and
a third resistor connected between the sixth end and ground.

6. The directional coupler according to claim 5, wherein the third coupler comprises:
a fifth circuit line having a ninth and tenth end;
a sixth circuit line having an eleventh and twelfth end, the eleventh end connected to the eighth end, the fifth and sixth circuit lines located proximate to each other such that they are electromagnetically coupled;
a fourth resistor connected between the ninth end and ground; and
a fifth resistor connected between the tenth end and ground.

7. The directional coupler according to claim 6, wherein the forward coupled port is connected to the twelfth end.

8. A directional coupler comprising:
a first, second and third coupler, each coupler having an input port, an output port, a forward coupled port and a reverse coupled port;
the forward coupled port of the first coupler connected to the input port of the second coupler, the reverse coupled port of the first coupler connected to resistor;
the output port of the second coupler connected to the input port of the third coupler, the output port of the third coupler forming a second forward coupled port.

9. The directional coupler according to claim 8, wherein each coupler comprises:
a first circuit line having a first and second end;
a second circuit line having a third and fourth end, the circuit lines located proximate to each other such that they are electromagnetically coupled.

10. The directional coupler according to claim 9, wherein a termination resistor is connected to each of the fourth ends and to the third ends of the second and third couplers.

11. The directional coupler according to claim 8, wherein the second and third couplers reduce the variation in coupling of the directional coupler over a frequency range.

12. A directional coupler comprising:
a housing having a cavity;
a first, second and third terminal mounted to the housing;
a printed circuit board mounted in the cavity, the circuit board having an upper surface and a lower surface;
a first coupler mounted to the circuit board, the first coupler having a first input port connected to the first terminal, a first output port connected to the second terminal and a first coupling forward port;
a second coupler mounted to the circuit board, the second coupler having a second input port connected to the first coupling forward port and a second output port;
a third coupler mounted to the circuit board, the third coupler having a third input port connected to the second output port and a third output port, the third output port connected to the third terminal.

13. The directional coupler according to claim 12, wherein the first coupler has a first reverse coupling port, a first resistor connected between the reverse coupling port and ground.

14. The directional coupler according to claim 12, wherein the second coupler has a second forward coupling port and a second reverse coupling port, a second resistor connected between the second forward coupling port and ground and a third resistor connected between the second reverse coupling port and ground.

15. The directional coupler according to claim 12, wherein the third coupler has a third forward coupling port and a third reverse coupling port, a fourth resistor connected between the third forward coupling port and ground and a fifth resistor connected between the third reverse coupling port and ground.

16. The directional coupler according to claim 12, wherein a plurality of resistors are mounted to the upper surface of the printed circuit board.

17. The directional coupler according to claim 12, wherein the first, second and third couplers are formed in a low temperature co-fired ceramic package.

18. The directional coupler according to claim 12, wherein the second and third couplers reduce the variation in coupling of the directional coupler over a frequency range.

19. The directional coupler according to claim 12, wherein a plurality of circuit lines are formed on the upper surface.

20. The directional coupler according to claim 12, wherein a first, second and third coaxial connector are mounted to the housing, the first, second and third terminals mounted in the first, second and third coaxial connectors, respectively.

21. The directional coupler according to claim 12, wherein the terminals are soldered to the printed circuit board.
